(19) United States
(12) Patent Application Publication
(10) Pub. No.: US 2014/0281994 A1
(43) Pub. Date: Sep. 18, 2014

(54) INTERACTIVE METHOD, TERMINAL DEVICE AND SYSTEM FOR COMMUNICATING MULTIMEDIA INFORMATION

(71) Applicant: Xiaomi Inc., Beijing (CN)

(72) Inventors: Xingsheng Lin, Beijing (CN); Zhiyong Feng, Beijing (CN); Hui Li, Beijing (CN); Jialin Fan, Beijing (CN); Hongqiang Zhang, Beijing (CN)

(73) Assignee: Xiaomi Inc., Beijing (CN)

(21) Appl. No.: 14/141,507

(22) Filed: Dec. 27, 2013

Related U.S. Application Data
(63) Continuation-in-part of application No. PCT/CN2013/081090, filed on Aug. 8, 2013.

(30) Foreign Application Priority Data
Mar. 15, 2013 (CN) 201310084054.6

(51) Int. Cl. G06F 3/0481; G06F 3/0484

(52) U.S. Cl. CPC G06F 3/0481; G06F 3/0484
USPC 715/719

(57) ABSTRACT

An interactive method, terminal device and system for communicating multimedia information are disclosed in the embodiments of the present disclosure. A sending terminal is configured to pop up a multimedia recording window at a preset location on a current conversation interface after a multimedia recording function is initiated, display the captured video information in the multimedia recording window, and send the multimedia information which is encoded in the current conversation interface after the recording of the multimedia information is finished. According to the present disclosure, a multimedia recording window and a multimedia player window are provided on a current conversation interface to implement the recording and playing of multimedia information, so that a smooth and continuous multimedia communication can be achieved with limited resources such as network bandwidth. Moreover, the transmission rate of information may be increased.

### CROSS-REFERENCE TO RELATED APPLICATIONS

This application is a Continuation-In-Part of International Application PCT/CN2013/081090, with an international filing date of Aug. 8, 2013, which claims the priority to Chinese Patent Application No. 201310084054.6, filed on Mar. 15, 2013, all of the entire contents of which are incorporated herein by reference.

### TECHNICAL FIELD

The present disclosure relates to communication technology field, and more particularly, to an interactive method, terminal device and system for transmitting multimedia information.

### BACKGROUND

With the rapid development of communication technology, mobile devices such as mobile phones have become daily necessities for a majority of people. Currently, video communication via a mobile device has become a popular way of communication. As a mobile device such as smart phone or tablet has gradually becoming more developed with improved video capturing ability, a user may tend to use the mobile device for capturing video or photo more frequently. Meanwhile, with the rapid development of mobile broadband service, there also has been an increased in demand for video transmission via a mobile device.

Traditionally, in the case of using an IM (Instant Messaging) tool available in the market to send video information, a sender needs to open a recording interface for recording a video from a conversation interface. The video is not recorded until the conversation interface reaches the recording interface, then returns to the conversation interface to send the recorded video after the recording is finished. A receiver may click the video to play it's contents after the video information has been received, and a playing interface for playing the video is opened, and then the video is played after the current interface reaches the playing interface for playing the video.

### SUMMARY

Embodiments of the present disclosure provide an interactive method, terminal device and system for transmitting multimedia information, which is capable of implementing the recording and playing of multimedia information in a current conversation interface, thereby achieving a smooth and continuous multimedia communication.

According to a first aspect, the present disclosure provides an interactive method for transmitting multimedia information comprising: popping up a multimedia record window at a preset location in a current conversation interface after a multimedia record function is initiated; displaying captured multimedia information in the multimedia recording window; sending the multimedia information which is encoded in the current conversation interface after the recording of the multimedia information is finished.

According to a second aspect, the present disclosure further provides an interactive method for receiving multimedia information comprising: receiving multimedia information; displaying the received multimedia information on a current conversation interface; decoding the received multimedia information after an operational instruction to play the multimedia information is received; and playing the decoded multimedia information in a multimedia player window popped up at a preset location on the current conversation interface.

According to a third aspect, the present disclosure further provides a sending terminal for transmitting multimedia information comprising: one or more processors; and a memory for storing instructions executable by the one or more processors; wherein the one or more processors are configured to execute steps comprising: popping up a multimedia recording window at a preset location on a current conversation interface after a multimedia recording function is initiated; displaying captured multimedia information in the multimedia recording window; and sending the multimedia information which is encoded in the current conversation interface after the recording of the multimedia information is finished.

According to a fourth aspect, the present disclosure further provides a receiving terminal for receiving multimedia information comprising: one or more processors; and a memory for storing instructions executable by the one or more processors; wherein the one or more processors are configured to execute steps comprising: receiving multimedia information; displaying the received multimedia information on a current conversation interface; decoding the received multimedia information after an operational instruction to play the multimedia information is received; and playing the decoded multimedia information in a multimedia player window popped up at a preset location on the current conversation interface.

According to a fifth aspect, the present disclosure further provides an interactive system for communicating multimedia information comprising: a sending terminal configured to pop up a multimedia recording window at a preset location on a current conversation interface after a multimedia recording function is initiated, display the captured video information in the multimedia recording window, and send the multimedia information which is encoded in the current conversation interface after the recording of the multimedia information is finished; and a receiving terminal configured to receive multimedia information and display the received multimedia information on the current conversation interface, decode the multimedia information after an operational instruction to play the multimedia information is received, and play the decoded multimedia information in a multimedia player window popped up at a preset location on the current conversation interface.

According to a sixth aspect, the present disclosure further provides a non-transitory computer-readable storage medium, which stores instructions for causing one or more processors to: pop up a multimedia recording window at a preset location on a current conversation interface after a multimedia recording function is initiated; display captured multimedia information in the multimedia recording window; and send the multimedia information which is encoded in the current conversation interface after the recording of the multimedia information is finished.

According to a seventh aspect, the present disclosure further provides a non-transitory computer-readable storage medium, which stores instructions for causing one or more processors to: receive multimedia information; display the received multimedia information on a current conversation interface; decode the received multimedia information after an operational instruction to play the multimedia information is received; and play the decoded multimedia information in a multimedia player window popped up at a preset location on the current conversation interface.

The advantageous effects provided by the embodiments of the present disclosure include in part the followings.

The interactive method, device, system and non-transitory computer readable storage medium as well as the sending terminal for transmitting multimedia information provided by the embodiments of the present disclosure pop up a multimedia recording window at a preset location on a current conversation interface after a multimedia recording function is initiated, display the captured video information in the multimedia recording window, and send the multimedia information which is encoded in the current conversation interface after the recording of the multimedia information is finished. The receiving terminal receives multimedia information and displays the received multimedia information on the current conversation interface, and after an operational instruction to play the multimedia information is received, it decodes the multimedia information and plays the decoded multimedia information in a multimedia player window popping up at a preset location on the current conversation interface.

With the interactive method, terminal device and system for transmitting multimedia information provided by the embodiments of the present disclosure, a multimedia recording window and a multimedia player window are provided in a current conversation interface to implement the recording and playing of multimedia information, so that a smooth and continuous multimedia communication can be achieved with limited resources such as network bandwidth. Meanwhile, the captured multimedia information may be transmitted at a low bit rate and frame rate, and thus the transmission rate of information may be increased.

### BRIEF DESCRIPTION OF THE DRAWINGS

FIG. 1 is a flowchart of an interactive method for transmitting multimedia information at a sending terminal according to an embodiment of the present disclosure.

FIG. 2 is a schematic view showing a conversation interface with a touch button A according to an embodiment of the present disclosure.

FIG. 3 is a schematic view showing a popup multimedia recording window according to an embodiment of the present disclosure.

FIG. 4 is a schematic view showing a conversation interface with a touch button C according to an embodiment of the present disclosure.

FIG. 5 is a flowchart of ending a recording of multimedia information according to an embodiment of the present disclosure.

FIG. 6 is a flowchart of an interactive method for sending multimedia information according to another embodiment of the present disclosure.

FIG. 7 is a flowchart of an interactive method for receiving multimedia information at a receiving terminal according to an embodiment of the present disclosure.

FIG. 8 is a schematic view showing a graphic display of the received multimedia information according to an embodiment of the present disclosure.

FIG. 9 is a schematic view showing a popup multimedia player window according to an embodiment of the present disclosure.

FIG. 10 is a flowchart of an interactive method for displaying multimedia information when a multimedia player window is popped up, according to an embodiment of the present disclosure.

FIG. 11 is a block diagram of an interactive apparatus for transmitting multimedia information according to an embodiment of the present disclosure.

FIG. 12 is a block diagram of an interactive apparatus for receiving multimedia information according to still another embodiment of the present disclosure.

FIG. 13 is a block diagram of an interactive system for communicating multimedia information according to an embodiment of the present disclosure.

Specific embodiments of the present disclosure have been illustrated in the above drawings and the detailed description thereof will be given hereinafter. These drawings and written description are only to illustrate the concept of the present disclosure with reference to the specific embodiments for those skilled in the art rather than limiting the scope conceived by the present disclosure in any manner.

### DETAILED DESCRIPTION OF THE PREFERRED EMBODIMENTS

Hereinafter, a detailed description will be given to an interactive method, terminal device, system and non-transitory computer readable storage medium for transmitting and receiving multimedia information provided by embodiments of the present disclosure.

According to the present disclosure, a sending terminal for performing the interactive method for transmitting multimedia information may be implemented using a variety of different types of electronic devices. Examples of such electronic devices may include mobile phones, computers, digital broadcast terminals, messaging devices, gaming consoles, tablets, medical devices, exercise equipment, personal digital assistants, and the like.

The sending terminal includes one or more processors to receive various data, programs and instructions, and to process such data, programs and instructions accordingly. The sending terminal also includes a memory which is coupled to the one or more processors and is configured to store the data, programs and instructions to be processed by the processors. Furthermore, the sending terminal may further include input modules, such as a touch screen, a camera, a keyboard, a mouse or the like. The touch screen is configured to provide both an output interface and an input interface between the sending terminal and a user. In some embodiments, the touch screen may include a liquid crystal display (LCD) and a touch panel (TP). The touch panel includes a plurality of touch sensors to sense touch operations on the touch panel. In certain embodiments of the present disclosure, a “touch button” is displayed in the screen to receive instructions from users.

The sending terminal may be provided with an operating system to implement data or instruction processing. The operating system may further include a user interface where interaction between a user and the sending terminal occurs. The user interface allows the user to manipulate the operating system of the sending terminal via user inputs, and allows the operating system to indicate the effects or reactions of the user's manipulation.

The sending terminal may be also installed with at least one applications/application programs, including without limitation, a browser application, a message application, an alarm application, a multimedia player application, a camera application, an instant messaging application, a music player application, etc. For example, the user may use a message application to exchange messages with his contacts.

In the following description, the interactive method for transmitting multimedia information in the sending terminal in accordance with some embodiments of the present disclosure is explained. While the process flow described below includes a plurality of steps that appear to occur in a specific order, it should be apparent that those procedures may include either fewer or more operations, which may be executed serially or in parallel.

Specifically, as shown in FIG. 1, an interactive method for transmitting multimedia information provided by an embodiment of the present disclosure includes the following steps.

Step 101 provides popping up a multimedia recording window at a preset location in a current conversation interface after a multimedia recording function is initiated.

Step 102 provides displaying captured multimedia information in the multimedia recording window.

Step 103 provides sending the multimedia information which is encoded in the current conversation interface after the recording of the multimedia information is finished.

For example, in an embodiment, the multimedia recording function may start after it is detected that an operational instruction to start the multimedia record function is triggered via a touch button in the current conversation interface. As shown in FIG. 2, a touch button A, on which a text or a graphic such as “press and hold to shoot” prompting a user is displayed, may be located at the bottom of the current conversation interface. When a user needs to send multimedia information, the user may press and hold the touch button A, and through this operation, the sending terminal determines that an operational instruction to start the multimedia recording function is detected, thereby starting the multimedia recording function.

Here, after the multimedia recording function has started, a multimedia recording window at a preset location on the current conversation interface is popped up. As shown in FIG. 3, a multimedia recording window B is popped up at the center of the current conversation interface. However, the preset location may not be limited to the center of the conversation interface, and may also be at any location of the current conversation interface. A prompting text such as “please pose for shoot” may be displayed around the multimedia recording window B. In addition, a front camera and a rear camera in the mobile terminal may be switched on by a preset user operation such as moving the mobile terminal from side to side.

For example, in an embodiment, displaying the captured multimedia information in the multimedia recording window may include instructing a camera application program to turn on the camera and displaying the multimedia information captured by the camera in the multimedia recording window. Meanwhile, audio information may be collected by an audio collecting component. Thereafter, the multimedia information including the video information and the audio information may be encoded according to a preset bit rate and frame rate. Here, the bit rate refers to the number of bits of data transmitted per unit time when the data is transmitted, and the general unit thereof is kbps, i.e. Kilobits per second. The bit rate is in proportion to the quality of the multimedia image, as well as the volume of a transmitted data. In order to rapidly process and transmit multimedia information, the multimedia information captured by the camera may be processed at a low bit rate. For example, the preset bit rate may be set as 40 kbps to 100 kbps, preferably, 48 kbps. The frame rate is a measurement used to measure the displayed number of frames, the measurement unit of which is FPS (Frames per second) or Hz. In order to rapidly process and transmit multimedia information, the multimedia information captured by the camera may also be processed at a low frame rate, e.g. 10 FPS to 20 FPS in the meantime.

For example, in an embodiment, after it is detected that an operational instruction to end the multimedia recording function is triggered or after it is detected that the recording time of the multimedia information exceeds a preset time, the recording of multimedia information may be ended. Specifically, as shown in FIG. 4, the current conversation interface may contain a touch button C on which a text or a graphic such as “end shoot” prompting a user is displayed. Upon finishing a multimedia recording, a user may click the touch button C, so that the mobile device detects the operational instruction to end the multimedia recording function and ends the multimedia recording. When it is required to hold a “press and hold to shoot” button such as touch button A, at all times, to capture multimedia information, then after the multimedia recording function has initiated, the multimedia recording function ends only when the touch button A is released without the use of the touch button C, or the prompt information displayed on the touch button A may be varied to a text or a graphic such as “end shoot” prompting the user.

In addition, whether the multimedia recording is finished is determined according to whether the duration of the multimedia recording exceeds a preset length of time. For example, a preset length of time is set for 10 seconds, and if it is detected that the duration of the recording exceeds 10 seconds, then a multimedia recording ends. As shown in FIG. 5, the specific process may include the following steps.

Step 501 provides starting timing when the multimedia recording function starts.

Step 502 provides detecting in real time whether the duration of the multimedia recording reaches a preset length of time, and if the duration of the multimedia recording does not reach the preset length of time, continue to carry out step 502, otherwise proceeding to step 503.

Step 503 provides determining that the recording is finished, and ending the multimedia recording function.

During the multimedia recording, the multimedia information captured by the camera may be displayed in the multimedia recording window, such that the user may review the quality of the recording. After the multimedia recording is finished, the multimedia information encoded by an encoding process may be sent in the current conversation interface.

Accordingly, from the above description, it is clear that with the interactive method for transmitting multimedia information provided by the embodiment of the present disclosure, the sending terminal provides a multimedia recording window in a current conversation interface to implement the recording of multimedia information, so that a smooth and continuous multimedia communication can be achieved with limited resources such as network bandwidth. Meanwhile, the captured multimedia information may be transmitted at a low bit rate and frame rate, and thus the transmission rate of information may be increased.

Taking the case of pressing and holding the touch button to perform multimedia recording as an example, a detailed description will be given to an interactive method for sending multimedia information provided by an embodiment of the present disclosure. The method includes the following steps.

In step 601, the method provides determining that an operational instruction to start a multimedia recording function is received after it is detected that a touch button in a current conversation interface is pressed.

In step 602, the method provides starting the multimedia recording function.

In step 603, the method provides popping up a multimedia recording window at a preset location on the current conversation interface.

In step 604, the method provides instructing a camera application program to turn on a camera, and displaying the video information captured by the camera in the multimedia recording window; calling an audio collecting component to collect audio information.

In step 605, the method provides encoding the multimedia information including the video information and the audio information, according to a preset bit rate and frame rate.

Wherein, during the above process, the user presses and holds the touch button at all times.

In step 606, the method provides determining that an operational instruction to end the multimedia recording function is received after it is detected that the touch button in the current conversation interface is released, and ending the multimedia recording.

In step 607, the method provides sending the encoded multimedia information in the current conversation interface.

Based on the sending terminal of the multimedia information, the above embodiment discloses that a multimedia recording window may be provided on the current conversation interface to implement the recording of multimedia information, so that a smooth and continuous multimedia communication can be achieved with limited resources such as limited network bandwidth. Meanwhile, the captured multimedia information may be transmitted at a low bit rate and a low frame rate, and thus the transmission rate of information might be increased.

Moreover, an embodiment of the present disclosure further provides an interactive method for receiving multimedia information in a receiving terminal. The receiving terminal for performing the interactive method for receiving multimedia information may be implemented using a variety of different types of electronic devices. Examples of such electronic devices may include mobile phones, computers, digital broadcast terminals, messaging devices, gaming consoles, tablets, medical devices, exercise equipment, personal digital assistants, and the like.

The receiving terminal includes one or more processors to receive various data, programs and instructions, and to process such data, programs and instructions accordingly. The receiving terminal also includes a memory which is coupled to the one or more processors and is configured to store the data, programs and instructions to be processed by the processors. Furthermore, the receiving terminal may further include input modules, such as a touch screen, a keyboard, a mouse or the like. The touch screen is configured to provide both an output interface and an input interface between the receiving terminal and a user. In some embodiments, the touch screen may include a liquid crystal display (LCD) and a touch panel (TP). The touch panel includes a plurality of touch sensors to sense touch operations on the touch panel. In certain embodiments of the present disclosure, a “touch button” is displayed in the screen to receive instructions from users.

The receiving terminal may be provided with an operating system to implement data or instruction processing. The operating system may further include a user interface where interaction between a user and the receiving terminal occurs. The user interface allows the user to manipulate the operating system of the receiving terminal via user inputs, and allows the operating system to indicate the effects or reactions of the user's manipulation.

The receiving terminal may be also installed with at least one applications/application programs, including without limitation, a browser application, a message application, an alarm application, a multimedia player application, a camera application, an instant messaging application, a music player application, etc. For example, the user may use a message application to exchange messages with his contacts.

In the following description, the interactive method for receiving multimedia information in the receiving terminal in accordance with some embodiments of the present disclosure is explained as shown in FIG. 7. The interactive method for receiving multimedia information includes the following steps.

Step 701 provides receiving multimedia information and displaying the received multimedia information on a current conversation interface.

Step 702 provides decoding the received multimedia information after an operational instruction to play the multimedia information is received and playing the decoded multimedia information in a multimedia player window popped up at a preset location on the current conversation interface.

After a mobile device such as a mobile phone receives multimedia information, the multimedia information is displayed on the current conversation interface. As shown in FIG. 8, after the multimedia information is received, an image D of the multimedia information, for example, an image of the first frame of the multimedia information, may be displayed on the current conversation interface of the receiving terminal.

For example, in an embodiment, after it is detected that the multimedia information displayed on the current conversation interface is clicked, it may be determined that an operational instruction to play the multimedia information is received. If the received multimedia information cannot be played automatically, the user may be required to click the multimedia information on the current conversation interface to play it.

For example, in an embodiment, the multimedia information is displayed in the preset location of the multimedia player window. When the multimedia information plays by clicking, the multimedia information may be played at the location where the multimedia information is displayed, that is, the location of the multimedia player window on the current conversation interface. It may also be played at other locations (e.g. at the center) on the current conversation interface, that is, the multimedia information may not display in the location of the multimedia player window. As shown in FIG. 9, the received multimedia information may be played in a multimedia player window E popped up from the current conversation interface.

Taking the case of popping up a multimedia player window as an example, a detailed description will be given to an interactive method for displaying multimedia information provided by the embodiment of the present disclosure, as shown in FIG. 10, which includes the following steps.

Step 1001 provides receiving multimedia information, and displaying the received multimedia information on a current conversation interface.

Step 1002 provides determining that an operational instruction to play the multimedia information is received after it is detected that the multimedia information displayed on the current conversation interface is clicked.

Step 1003 provides decoding the received multimedia information.

Step 1004 provides popping up a multimedia player window at a preset location in the current conversation interface.

Step 1005 provides playing the multimedia information in the multimedia player window.

From the description of the embodiment, it is clear that with the method provided by the embodiment of the present disclosure, the multimedia receiving terminal provides a multimedia player window on the current conversation interface to implement the playing of multimedia information, so that a smooth and continuous multimedia communication can be achieved with limited resources such as limited network bandwidth. Meanwhile, the captured multimedia information may be transmitted at a low bit rate and a low frame rate, and thus the transmission rate of information may be increased.

The functions described according to the accompanying drawings may be accomplished in one terminal device, meaning that the multimedia sending terminal and the multimedia receiving terminal may be combined in a terminal device. That is, a terminal device has the functions of both sending and receiving multimedia information as mentioned in the embodiment of the present disclosure.

Based on the same invention concept, an interactive apparatus for transmitting multimedia information is further provided by an embodiment of the present disclosure. Since the principle of the apparatus to solve the problem is similar to that of the interactive method for transmitting multimedia information mentioned above, the implementation of the apparatus may refer to that of the method. Therefore, the repetitive description will be omitted.

As shown in FIG. 11, an interactive apparatus for transmitting multimedia information provided by an embodiment of the present disclosure includes: a popup module 1101 configured to pop up a multimedia recording window at a preset location on a current conversation interface after a multimedia recording function is initiated; a recording module 1102 configured to display captured multimedia information in the multimedia recording window; a sending module 1103 configured to send the multimedia information which is encoded in the current conversation interface after the recording of the multimedia information is finished.

For example, the interactive apparatus may further include: a starting module 1104 configured to start a multimedia recording function, after it is detected that an operational instruction to start the multimedia recording function after an operational instruction for starting the multimedia recording is detected.

For example, the recording module 1102 may be configured to instruct a camera application program to turn on a camera, and display the multimedia information captured by the camera in the multimedia recording window.

For example, the interactive apparatus may further include: an encoding module 1105 configured to encode the captured multimedia information including video information and audio information according to a preset bit rate and frame rate.

For example, the interactive apparatus may further include: an ending module 1106 configured to end the multimedia recording after an operational instruction for ending the multimedia recording is detected, or end the multimedia recording after it is detected that a duration of the multimedia recording exceeds a preset length of time.

As shown in FIG. 12, another embodiment of the present disclosure further provides an interactive apparatus for receiving multimedia information comprising: a display module 1201 configured to receive multimedia information, and display the received multimedia information on a current conversation interface; a playing module 1202 configured to decode the received multimedia information after an operational instruction to play the multimedia information is received and play the decoded multimedia information in a multimedia player window popped up at a preset location on the current conversation interface.

For example, the interactive apparatus may further include: a determination module 1203 configured to determine that an operational instruction to play multimedia information is received after it is detected that the multimedia information displayed on the current conversation interface is clicked.

From the above description, it is clear that with the interactive apparatuses for transmitting and receiving multimedia information provided by the embodiment of the present disclosure, a multimedia recording window or a multimedia player window are provided in a current conversation interface to implement the recording and playing of multimedia information, so that a smooth and continuous multimedia communication can be achieved with limited resources such as limited network bandwidth. Meanwhile, the captured multimedia information may be transmitted at a low bit rate and a low frame rate, and thus the transmission rate of information may be increased.

Based on the same invention conception, an interactive system for communicating multimedia information is also provided by an embodiment of the present disclosure. Since the principle of the system to solve the problem is similar to that of the above-mentioned interactive method for transmitting and receiving multimedia information, the implementation of the system may refer to that of the method. Therefore, the repetitive description will be omitted.

As shown in FIG. 13, an interactive system for communicating multimedia information further provided by an embodiment of the present disclosure includes: a sending terminal 1301 configured to pop up a multimedia recording window at a preset location on a current conversation interface after a multimedia recording function is initiated, display the captured video information in the multimedia recording window, and send the multimedia information which is encoded in the current conversation interface after the recording of the multimedia information is finished; a receiving terminal 1302 configured to receive multimedia information and display the received multimedia information on the current conversation interface, decode the multimedia information after an operational instruction to play the multimedia information is received, and play the decoded multimedia information in a multimedia player window popped up at a preset location on the current conversation interface.

From the above description, it is clear that with the interactive methods, terminal devices, and system for transmitting and receiving multimedia information provided by the embodiments of the present disclosure, a multimedia recording window or a multimedia player window may be provided in the current conversation interface to implement the recording and playing of multimedia information, so that a smooth and continuous multimedia communication can be achieved with limited resources such as limited network bandwidth. Meanwhile, the captured multimedia information may be transmitted at a low bit rate and a low frame rate, and thus the transmission rate of information may be increased.

Through the above description to the embodiments, it can be clearly understood by those skilled in the art that, the embodiments of the present disclosure may be implemented by hardware, or by software working with necessary common hardware platform. Based on this understanding, the technical solution of the embodiments of the present disclosure may be embodied in a form of software product which may be stored in a non-transitory storage medium (such as CD-ROM, flash disk, or mobile hard disk, etc.) and which may include a series of instructions to enable a terminal device (such as mobile phone, or tablet, etc.) to implement the methods described in the embodiments of the present disclosure.

The non-transitory computer readable storage medium may use, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof.

For a software implementation, the embodiments described herein may be implemented with separate software modules, such as procedures and functions, each of which perform one or more of the functions and operations described herein. The software codes can be implemented with a software application written in any suitable programming language and may be stored in memory of the terminal.

The aforementioned methods can be implemented in a non-transitory computer readable storage medium recording computer-readable codes. The non-transitory computer readable storage medium includes all kinds of recording devices in which data readable by a computer system are stored. The non-transitory computer readable storage medium includes ROM, RAM, CD-ROM, magnetic tapes, floppy discs, optical data storage devices, and the like, as well as carrier-wave type implementations (e.g., transmission via Internet).

It can be understood by those skilled in the art that, the accompanying drawings are only illustrative diagrams for the preferred embodiments, and the modules or the procedures in these drawings may not be necessary for implementing the present disclosure.

It can be understood by those skilled in the art that, the modules in a device of the embodiment may be distributed in the apparatus according to the description of the embodiments, or may vary to be contained in one or more apparatus other than that of this embodiment. The modules in the above embodiments may be combined as one module, or may be further divided into several sub-modules.

The aforementioned arrangement of the embodiments of the present disclosure is merely for description purpose, not relating to showing the superiority or inferiority of the embodiments.

It is obvious that those skilled in the art may make various modifications and variation to the present disclosure without departing from the intent and scope of the present disclosure. Accordingly, if such modification and variation fall within the scope of the claims of the present application or equivalents thereof, the present application intends to embrace such modification and variation.

What is claimed is:

1. An interactive method for transmitting multimedia information, comprising:
popping up a multimedia recording window at a preset location on a current conversation interface after a multimedia recording function is initiated;
displaying captured multimedia information in the multimedia recording window; and
sending the multimedia information which is encoded in the current conversation interface after the recording of the multimedia information is finished.

2. The interactive method according to claim 1, further comprising:
starting the multimedia recording function after an operational instruction for starting the multimedia recording is detected.

3. The interactive method according to claim 1, wherein displaying the captured multimedia information in the multimedia recording window comprises:
instructing a camera application program to turn on a camera; and
displaying the multimedia information captured by the camera in the multimedia recording window.

4. The interactive method according to claim 2, wherein displaying the captured multimedia information in the multimedia recording window comprises:
instructing a camera application program to turn on a camera; and
displaying the multimedia information captured by the camera in the multimedia recording window.

5. The interactive method according to claim 3, further comprising:
encoding the captured multimedia information including video information and audio information according to a preset bit rate and frame rate.

6. The interactive method according to claim 1, further comprising:
ending the multimedia recording after an operational instruction for ending the multimedia recording is detected.

7. The interactive method according to claim 1, further comprising:
ending the multimedia recording after it is detected that a duration of the multimedia recording exceeds a preset length of time.

8. An interactive method for receiving multimedia information, comprising:
receiving multimedia information;
displaying the received multimedia information on a current conversation interface;
decoding the received multimedia information after an operational instruction to play the multimedia information is received; and
playing the decoded multimedia information in a multimedia player window popped up at a preset location on the current conversation interface.

9. The interactive method according to claim 8, wherein the operational instruction for playing the multimedia information is received after it is detected that the multimedia information displayed on the current conversation interface is clicked.

10. The interactive method according to claim 8, wherein the multimedia information is displayed in the preset location of the multimedia player window.

11. A sending terminal for transmitting multimedia information, comprising:
one or more processors; and
a memory for storing instructions executable by the one or more processors;
wherein the one or more processors are configured to execute steps comprising:
popping up a multimedia recording window at a preset location on a current conversation interface after a multimedia recording function is initiated;
displaying captured multimedia information in the multimedia recording window; and
sending the multimedia information which is encoded in the current conversation interface after the recording of the multimedia information is finished.

12. The sending terminal according to claim 11, the one or more processors are further configured to execute steps comprising:
starting the multimedia recording function after an operational instruction for starting the multimedia recording is detected.

13. The sending terminal according to claim 11, wherein displaying the captured multimedia information in the multimedia recording window comprises:
instructing a camera application program to turn on a camera; and
displaying the multimedia information captured by the camera in the multimedia recording window.

14. The sending terminal according to claim 13, wherein the one or more processors are further configured to execute steps comprising:
encoding the captured video information and audio information according to a preset bit rate and frame rate.

15. The sending terminal according to claim 11, wherein the one or more processors are further configured to execute steps comprising:
ending the multimedia recording after an operational instruction for ending the multimedia recording is detected.

16. The sending terminal according to claim 11, wherein the one or more processors are further configured to execute steps comprising:
ending the multimedia recording after it is detected that a duration of the multimedia recording exceeds a preset length of time.

17. A receiving terminal for receiving multimedia information, comprising:
one or more processors; and
a memory for storing instructions executable by the one or more processors;
wherein the one or more processors are configured to execute steps comprising:
receiving multimedia information;
displaying the received multimedia information on a current conversation interface;
decoding the received multimedia information after an operational instruction to play the multimedia information is received; and
playing the decoded multimedia information in a multimedia player window popped up at a preset location on the current conversation interface.

18. The receiving terminal according to claim 17, wherein the operational instruction for playing the multimedia information is received after it is detected that the multimedia information displayed on the current conversation interface is clicked.

19. An interactive system for communicating multimedia information, comprising:
a sending terminal configured to pop up a multimedia recording window at a preset location on a current conversation interface after a multimedia recording function is initiated, display the captured video information in the multimedia recording window, and send the multimedia information which is encoded in the current conversation interface after the recording of the multimedia information is finished; and
a receiving terminal configured to receive multimedia information and display the received multimedia information on the current conversation interface, decode the multimedia information after an operational instruction to play the multimedia information is received, and play the decoded multimedia information in a multimedia player window popped up at a preset location on the current conversation interface.
